(19) United States
(12) Patent Application Publication
(10) Pub. No.: US 2004/0133997 A1
(43) Pub. Date: Jul. 15, 2004

(54) Fiber reactive dyeing system

(76) Inventors: David R. Kelly, Oglethorpe, GA (US); Mark A. Brophy, Chattanooga, TN (US); James L. Williams, Marietta, GA (US)

Correspondence Address: Craig M. Lundell, HOWREY SIMON ARNOLD & WHITE, LLP, P.O. Box 4433, Houston, TX, 77210-4433, US

(21) Appl. No.: 10/342,781

(22) Filed: Jan. 15, 2003

(51) Int. Cl. C09B 62/00

(52) U.S. Cl. 8/549

(57) ABSTRACT

A method for dyeing fiber including, contacting the fiber with fiber reactive dye and fixing the dye utilizing an alkali metal carbonate.

### FIELD OF THE INVENTION

The present invention is generally directed to dyeing of synthetic stain resistant fibrous material and to products made therefrom.

### BACKGROUND

Nylon fiber is widely used in the manufacture of carpets and other textile materials. For aesthetic and utilitarian purposes, nylon fiber may be colored using a variety of techniques. One method is to dye the fiber using acid dyes, which are anionic dyes with relatively low molecular weights that carry from one to three sulfonic acid groups. Acid dyes are known to ionically bond to the terminal amino, imido and other positively charged sites in the nylon polymer.

Another way to color nylon fiber is to include a pigment in the polymer melt from which the nylon fiber is spun. By using pigments to impart color to the nylon fiber, a permanent and more uniform coloration of the fiber may be achieved. Unfortunately, pigmented nylon fiber can be unintentionally “dyed”, that is to say, stained by natural or artificial acid dyes existing in some foods and drinks when they are spilled onto nylon carpets and other textile materials.

A common solution to this problem is to topically apply to the surface of the pigmented nylon fiber a material that will function as a “stain-blocking” agent. Although very effective in the short term, such treatments wear off long before the end of the useful life of the carpet or textile material. Further, such treatment may be accidentally removed by detergents or other cleaning agents that may be used on the carpet or other textile material.

Alternatively, it is known that small amounts of certain materials that impart cationic dyeability to nylon, such as aromatic sulfonates and their alkali metal salts, can be copolymerized with the nylon as a means of rendering the nylon resistant to staining by synthetic and natural acid dyes. For example, in U.S. Pat. No. 5,108,684, the entire subject matter of which is incorporated herein by reference, describes a method of making an acid dye resistant pigmented nylon fiber. Other cationic dyeable nylons are made using various methods, such as those described in U.S. Pat. Nos. 3,542,743; 3,846,507; 3,898,200; 5,889,138; 6,117,550; and 6,133,382, the entire subject matter of which is incorporated herein by reference.

Even though cationic dyeable (CD) nylons offer good stain resistant properties, they have suffered from various dyeability deficiencies and poor dye lightfastness when dyed with cationic dyes. By their nature, CD nylons are not readily dyeable with acid dyes. In U.S. Pat. No. 5,085,667, the entire subject matter of which is incorporated herein by reference, acid and premetallized acid dyes are disclosed as being useful in dyeing CD nylon fiber. However, the resulting dyed fiber fails to pass ordinary wetfastness tests and cannot be exposed to boiling water. U.S. Pat. No. 5,417,724, the entire subject mater of which is incorporated herein by reference, seeks to remedy this bleeding problem by describing a fixing agent that is applied to the fiber surface, which blocks the sites of the nylon fiber thereby trapping the dye in the fiber. Because such a fixing agent is topical and is not bound to the surface of the fiber, it is susceptible to being removed during use and during cleaning.

U.S. Pat. No. 5,445,653, the entire subject matter of which is incorporated herein by reference, relate to the incorporation of fiber reactive dyes in CD nylon fiber. Since such dyes are covalently bound directly to the fiber, dye bleeding is virtually eliminated even after extended use and vigorous cleaning of the fiber. However, there remains a need for a stain resistant synthetic fiber that may be readily dyeable if desired, and that is not susceptible to dye bleeding.

### SUMMARY OF THE INVENTION

The present invention is directed to a method for dyeing synthetic cationic dyeable fiber by contacting the fiber with fiber reactive dye and covalently bonding the dye to the fiber using alkali metal carbonate. The present invention is also related to a method for making carpet, including dyeing synthetic cationic fiber with fiber reactive dye to form a dyed fiber, combining the dyed fiber with undyed dyeable fiber or acid dyeable fiber to form the carpet, and overdyeing the carpet with another dye. The present invention also relates to a method for making carpet including dyeing synthetic cationic dyeable fiber with fiber reactive dye to form dyed fiber and tufting the dyed fiber with fiber including dyed or pigmented fiber.

An embodiment the present invention relates to synthetic cationic dyeable fiber including fiber reactive dye, wherein the dye is fixed by alkali metal carbonate. A further embodiment of the present invention relates to a mixture of synthetic cationic dyeable fiber and dyes including the fiber, the dye and alkali metal carbonate.

Another embodiment of the present invention is directed to carpet made of synthetic cationic dyeable fiber dyed with fiber reactive dye, tufted with fiber including undyed cationic or acid dyeable fiber, the carpet being overdyed with a dye such as an acid dye or a premetallized acid dye. A further embodiment of the present invention relates to a carpet made of synthetic cationic dyeable fiber dyed with a fiber reactive dye tufted with fiber including dyed or pigmented fiber.

### DETAILED DESCRIPTION OF PREFERRED EMBODIMENTS

It is object of the present invention to provide a method of dyeing synthetic cationic dyeable fiber, especially cationic dyeable Type 6 and Type 66 nylon and light dyeable Type 66 nylon, so that the dyed fiber will resist taking on further dye (or unintentional stain), and will have a high degree of wash and bleed fastness, even if the dyed fiber is subjected to a further high temperature treatment, including further dyeing or vigorous washing. The term “fiber”, as used herein, is defined to include not only staple fiber and continuous filament, but also yarns made therefrom.

Such dyeing of the cationic dyeable nylon fiber may be accomplished by a batch dye or continuous dye procedure. The batch dye method involves the dyeing of a fixed amount of material in a closed vessel. Such equipment used in the industry would include dyebecks used to dye carpets and fabrics, dyejets used to dye fabric and knitted yarns, skein dye machines used to dye yarns in skein form, package machines used to dye yam packages and stock dye machines used to dye the fiber in staple form. The continuous dye technique includes, but is not limited to, solid shade flood or Kuesters dyeing and multicolor space dyeing or printing.

In the batch dye method, the fiber is placed into the machine and the fiber reactive dye is mixed with water to affect a desired bath ratio, preferably less than 25 to 1. Dye assist chemicals may be added which may include non-ionic wetting agents, anionic leveling agents, sequestering and/or anti-chlor chemicals.

In an embodiment of the present invention, the fiber reactive dye is vinylized or previnylized utilizing alkali metal carbonates. Preferably, the alkali carbonate is potassium carbonate (K₂CO₃) or lithium carbonate (Li₂CO₃), and more preferably, the alkali carbonate is lithium carbonate. K₂CO₃ is preferable for enhanced solubility and lower cost, but Li₂CO₃ is the most effective. The amount of fiber reactive dye added to the dye solution may vary depending on the dye and alkali utilized and shade of dyeing desired. By using the alkali metal carbonates according to the present invention, the amount of fiber reactive dyes required is significantly reduced and the amount of dyes incorporated in the nylon is significantly increased as compared to the use of ordinary alkalis, such as phosphates. The amount of alkali metal utilized in the process may range from about 0.5 to about 50, preferably from about 0.5 to about 40, and more preferably from about 0.5 to about 30 grams per liter of dye solution.

According to the present invention, sufficient acid is added to the dye solution to make it extremely acidic, i.e., to reduce its pH to no higher than 1.5, and preferably to the range of 0.5 to 1.5. It is believed that reduction to this very low pH range is instrumental in giving the dye the ability to color cationic dyeable and light dyeable Type 66 nylon, which otherwise cannot be successfully dyed by fiber reactive dyes. Although any strong acid may be utilized, preferred acids include sulfamic and sulfuric acids.

Other constituents may be added to the dye solution such as a gum or thickener, wetting agents, penetrating agents, and anti-foaming agents, and mixed to provide a homogeneous dye solution or print paste.

In batch dyeing, the dye solution may be set at a temperature of 90 to 120 degrees F. The temperature is raised at 3 degrees F per minute to a temperature of at least 160 degrees F, but more preferably to a temperature of 180 to 212 degrees F. Dyeing of the fiber, yarn or carpet is effected for at least five minutes or as long as desired for dye exhaust. If the yarn or tufted carpet is to be continuous dyed, the dye is applied with the desired wet pick-up and steamed for about one minute for yarn and up to about twelve minutes for tufted carpet.

After the dye is applied, covalent bonding of the fiber reactive dyes to the synthetic cationic dyeable fiber is affected by exposing the fiber to an alkali in a fresh bath. Ideally, the alkali is an alkali metal carbonate such as potassium or lithium carbonate. Exposure to the alkali should be completed at a temperature of about 90 to 160 degrees F. with about 140 to 150 degrees F being the preferred temperature. The fiber, yarn or carpet may then be rinsed cold and dried.

Because alkalis, such as TSP, have similar chemical and physical properties as alkali metal carbonates, one of ordinary skill in the art would have expected the carbonates to have performed similarly in the dye covalent bonding process. In direct contrast, the present invention (as shown in Table 2) demonstrates that alkali metal carbonates provide a superior amount of dye covalently bonded to the fiber.

This invention is applicable to any type of synthetic cationic dyeable fiber produced by any manufacturer with excellent covalent bond fixation and stain resistance such as those obtained with nylon, especially on Type 66 nylon and Type 6 nylon. Preferred cationic yarns may be Types JBT, JBJ and BBT from Solutia and Types 854, 494, 744 and 543A from Dupont. The invention also works very well on Type-66 light dyeable nylon although it will tend to stain heavier than cationic nylon in an overdye situation. Preferred light dye yarns include Type MET from Solutia and Types 855, 745 and 495 from Dupont.

The condition of the fiber being dyed is immaterial. It may be rawstock, singles or plied yarns or tufted carpets. The yarns may be heatset by any method, including but not limited to Superba or Seussan.

Fiber reactive dyes that are suitable for use in the present invention include those setforth in the U.S. patent application No. 5,972,046, the entire subject matter of which is incorporated herein by reference. Chemically acceptable dyestuffs include, but are not limited to, vinyl sulfones, chloro-triazines or bromo-acrylimides. Preferred dyes include:

Fourtex Yellow 3 GN

Fourtex Yellow 2GR 150%

Fourtex Orange HF-2R

Fourtex Red 3B

Fourtex Red BS

Fourtex Blue 2GR 150%

Fourtex Navy S-G

Riconyl Red RY

Rite Reactive Yellow BF-3G

Rite Reactive Navy BF-2G

Lanasol Blue 3G

Such dyes are readily available from dye manufacturers, such as Ciba Corp. in Greensboro, N.C.; Rite Industries in Dalton, Ga.; and Fourcolors Acquisitions Inc. in Dalton, Ga. In this invention, the chemical structure of the dye appears to have less to do with performance than does the individual characteristics of the dye at ultra low pH.

Fiber dyed by this invention will have an ultra high degree of wet fastness. These fibers may be spun into yams or made as continuous filament yarns, which may be combined into a carpet with regular or deep acid dyeable yams and then overdyed in a boiling dyebath with acid dyes. The acid dyes do not stain the cationic dyeable nylon and the fiber reactive dyes used to dye the cationic dyeable nylon do not bleed and do not stain the acid dyeable nylon. The yams may be tufted into a griege carpet and then batch dyed into a solid shade. Such carpets have superior wet and bleed fastness in shampoo and steam cleaning situations. Also, yams made by this invention may be combined with other selected predyed and solution dyed yams to make multicolor carpet. Carpets made with cationic nylon yarns dyed with fiber reactive dyes at low pH and applied with alkali metal carbonates will have high order of stain resistance against common household items which are anionic in nature.

In another embodiment of the present invention, a carpet is constructed utilizing fiber/yarn dyed with fiber reactive dyes wherein the dyes are vinylized and/or covalently bonded to the fiber using an alkali metal carbonate. Such a carpet may be manufactured by dyeing cationic dyeable yam with fiber reactive dye (by either space dyeing, skein dyeing, stock dyeing, or other conventional yam dyeing processes) to form dyed yarn, tufting the dyed yarn with undyed cationic dyeable yam to form the carpet, and overdyeing the carpet. The overdyeing process may include batch or continuous dyeing processes, including but not limited to beck dyeing, piece dyeing, pad dyeing, jet dyeing, or other conventional carpet dyeing processes.

In a further embodiment of the present invention, a carpet is constructed by dyeing cationic dyeable yarn with fiber reactive dye to form a dyed yarn and tufting the dyed yarn with yarn including dyed or pigmented yarn. The dyed or pigmented yarn may be produced in a conventional manner. Preferably the dyed yarn is cationic dyeable yarn that is dyed with fiber reactive dyes as described herein.

In another embodiment of the present invention, a carpet is produced utilizing synthetic cationic dyeable fiber dyed with fiber reactive dye and tufted with fiber, including undyed synthetic acid dyeable fiber, the carpet then being overdyed with a dye such as an acid or premetallized acid dye.

The fiber or yarn described herein may be any cationic dyeable fibers, but is preferably composed of polyamide (e.g., nylon 6, nylon 66, nylon 69, nylon 612, etc.) and may include copolymers thereof. More preferably, the polyamide is nylon 66.

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLES

A method used to evaluate the effectiveness of this invention is the 210 degrees F. overdye test (which measures the amount of fiber reactive dye bleed from the cationic dyeable fiber). In this method, 25% of the fiber, which is dyed with fiber reactive dyes, is combined with 75% of regular undyed KET cationic (available from Solutia Inc.) nylon in a beaker. A blank bath is set at a bath ratio of about 25-40 of water to 1 of nylon sample with 1.0% of an anionic or amphoteric leveling agent and 0.5% of a non-ionic wetting agent at a pH of about 6 to assimilate batch dyeing. The bath is then raised to 210 degrees F. and run for 40 minutes. The samples are rinsed cold and dried. Acceptable results are a fiber reactive dye fade of no more than a “4” break on the AATCC Gray Scale and a stain on the KET nylon of no more than a “4” on the AATCC Stain Scale.

### Examples I-IV

The dyed fiber is obtained using 1360/1 non-heatset Solutia JBT cationic dyeable nylon (available from Solutia Inc.). A 2000-cc dye solution was prepared and aliquoted into four 500-cc beakers, each containing the identical dye formulation:

| | |
|---|---|
| 0.30% | FOURTEX YELLOW 2GR 150% (available from Fourcolors |
| owf | Acquisitions, Inc.) |
| 0.5 | FOURTEX RED 4BD (available from Fourcolors Acquisitions, |
| | Inc.) |
| 0.6 | FOURTEX NAVY S-G (available from Fourcolors Acquisitions, |
| | Inc.) |

Yellow 2GR 150% and Navy S-G are selected because of their known good fixation properties. Red 4BD is-selected because it is suspected to be alkali sensitive for dye fixation.

Each aliquot is previnylized by adding the carbonates (A-C) or phosphate (D) to a pH=9.5 as follows:

A. with K₂CO₃

B. with Li₂CO₃

C. with Na₂CO₃

D. with Na₃PO₄

It takes about two times the amount of Na₂CO₃ and Na₃PO₄ to previnylize the dye than is consumed with K₂CO₃ and Li₂CO₃. Molar concentration comparison is not possible since it takes such small quantities to previnylize lab dyeings.

The pH of each dye sample is then adjusted to about 1.2 with sulfamic acid.

The following dyeing assistants are added to each dye sample:

| | |
|---|---|
| 0.5% | FOUR LEV R (leveling agent available from Fourcolors |
| owf | Acq. Inc., Dalton, GA) |
| 0.5% | LANAWET 916(wetting agent available from Lenmar - |
| | Chemical, Dalton, GA) |

A 20-cc sample of each dyebath is taken (A, B, C, D)

A 20-gram knit yarn sample of 1360/1 JBT is dyed in each dyebath at a bath ratio of 25 to 1 for 30 minutes at 212° F. Each yarn sample is dyed to a medium greenish brown shade. A 20-cc sample of each exhausted dyebath is taken (A2, B2, C2, D2). Each yarn sample is rinsed in cold water.

Separate baths are prepared for afterfix evaluation of the yarn Samples. Since the currently preferred afterfix method utilized 30 g/l of a 50% solution of K₂CO₃, this is l chosen as the molar standard.

Yarn Sample A is aftertreated by adding it to 15 g/l of K₂CO₃—a 0.22 molar solution.

Yarn Sample B is aftertreated by adding it to 7.92 g/l of Li₂CO₃—a 0.22 molar solution

Yarn Sample C is aftertreated by adding it to 11.44 g/l of Na₂CO₃—a 0.22 molar solution

Yarn Sample D is aftertreated by adding it to 17.60 g/l of Na₃PO₄—a 0.22 molar solution

Each yarn Sample aftertreatment is performed at 160° F. for 15 minutes, and then each yarn Sample is dried. Each yarn Sample is then subjected to the 210° F. overdye test to assimilate beck overdyeing. A 2.5 gram cut of each dyed yarn Sample is combined with 7.5 grams of 1360/1 KET in a blank aqueous bath containing:

| | |
|---|---|
| 1.0% | FOUR LEV R |
| 0.5% | LANAWET 916 |
| | MSP to pH = 6.0 |

The yarn Samples are run in the blank bath for 40 minutes at 210° F. A 20-cc sample of each bath is taken to compare dye washout (A3, B3, C3, D3). They are then rinsed cold and dried. The yarn samples are rated under fluorescent light using an AATCC Gray Scale for color change and an AATCC Stain Scale for dye staining on the KET. The results are setforth in Table 3.

The 20-cc bath samples (A3, B3, C3, D3) that are collected are tested for IR light transmittance in a spectrophotometer. The original dyebath (A, B, C, D) and the exhausted dyebath (A2, B2, C2, D2) samples are compared to measure the percentage of dye exhaust by each alkali used in previnylization. The results are shown in Table 1. The samples (A3, B3, C3, D3) collected after the afterfix by each alkali are compared with K₂CO₃ to measure relative dye fixation. The results are shown in Table 2.

Table 1 shows the dye exhaustion obtained by each alkali used in previnylization. Li₂CO₃ is slightly improved over K₂CO₃, which is improved over TSP. However, an 80 to 85% dyebath exhaust in a shade of this depth is not considered poor because of the known hydrolyzation properties of fiber reactive dyes.

Table 2 shows the relative dye washout subsequent to the alkali aftertreatments. This difference is significant and very unexpected. In the chromatic measurement, Li₂CO₃ is somewhat better for dye fixation than K₂CO₃, and Na₂CO₃ and TSP is considerably worse than all of the alkali metal carbonates.

Table 3 is the visual ratings of the 210° F. overdye test. It clearly shows that Li₂CO₃ performs best with this particular fiber reactive dye combination and that TSP is a failure.

This test indicates that Li₂CO₃ is the best of the four tested alkalis and that K₂CO₃ offers good performance in both previnylization and afterfixation in dyeing with the process of the present invention. The results in Table 2 are decisive. Unexpectedly, Na₂CO, Li₂CO₃, and K₂CO₃ will fix and retain substantially more dye than TSP on an equal molar basis.

### Example V

A knitted yam sample of 1360/1 Solutia JBT nylon is cut into six separate 20 gram samples. Each of these samples is placed in a laboratory dye beaker with 1.0% Fourlev R and 0.5% Lanawet 916 at a bath ratio of 40 to 1. Each sample is dyed with 0.6% Fourtex Navy S-G which has been previnylized with potassium carbonate as described in Example I. Each sample is dyed at a separate pH as follows:

#1 at pH=1.0

#2 at pH=1.4

#3 at pH=1.8

#4 at pH=2.2

#5 at pH=2.6

#6 at pH=3.0

The samples are dyed at the boil (i.e., 212 degrees F). After dyeing, a fresh bath is set with 30g/l of potassium carbonate and the samples are aftertreated at 160F to effect covalent bonding.

The above procedure is repeated exactly except that 0.6% of an acid dye, Tectilon Blue BRL (Acid Blue 324), is used. All 12 of the samples are given a 210 degrees F overdye test, as described in Example I.

The results of this test show that the fiber reactive blue dye has excellent color yield at pH of 1.0 and 1.4. At pH 1.8, the color yield is less than 50%, and above that, fell off to zero color yield. The acid blue shows good color yield at all pH's. In the 210 degrees F overdye test, the fiber reactive dyed samples dyed at pH's of 1.0, 1.4, and 1.8 exhibited no washdown and no stain of the 1360/1 KET regular dye nylon yarn. All of the acid dye dyed samples fail this test for both washdown and stain.

This evaluation clearly shows that fiber reactive dyes and acid dyes dye cationic dyeable nylon by different mechanisms. It appears that fiber reactive dyes form covalent bonds whereas acid dyes form ionic bonds.

### Example VI

The method of EXAMPLE V is repeated except Fourtex Red BS is used as the fiber reactive dye and Nylanthrene Red B2BSA (Acid Red 266) is used as the acid dye. The results and conclusions are the same as Example V.

### Example VII

Samples of Dupont Type 494 cationic nylon and Solutia Type JBT cationic nylon are obtained and knitted into separate tubes. A 25 gram sample of each knitted yarn is placed in a dye beaker (batch dye bath) at a bath ratio of 25 to 1 with 1.5% of Hostuspur CX and 0.25% of EDTA sequestering agent. The following dye combination is weighed up and previnylized with potassium carbonate (as described in Example 2) until the pH of the well dissolved dyes is stabilized at 9.5:

| | |
|---|---|
| 0.45% | Fourtex Yellow 2GR 150% |
| 0.05% | Fourtex Red BS |
| 0.55% | Rite Reactive Navy BF-2G |

The vinylized dyes are added to the beaker and the pH is dropped to 1.25 with sulfamic acid. The temperature of the batch dye baths is raised to 212F and the samples are dyed (exposed to the dye bath while boiling) for 20 minutes.

A fresh bath is set with 30g/l of potassium carbonate and the samples are mixed for 10 minutes at 160F. The samples are rinsed cold and dried. Each sample is a clear green color with the Solutia yarn being about 20% heavier in depth of shade than the Dupont yarn. Both yarns are tested in the 210F overdye test described in EXAMPLE I and passed with virtually no stain or washdown.

### Example VIII

One hundred pounds of Solutia bright cationic dyeable staple is loaded into a stock dye machine at a bath ratio of about 7 to 1. Added chemicals are 1.0% Fourlev R and 0.5% Lanawet 916. The following dye formulation is previnylized with potassium carbonate and added to the machine:

| | |
|---|---|
| 0.66% | Fourtex Yellow 3GN |
| 0.26% | Rite Reactive Navy BF-2G |

Sulfamic acid is added until the dyeing pH is set at 1.1. The temperature is raised to 210 degrees F at 3 degrees F per minute and the fiber is dyed for 30 minutes. A sample is taken and the shade is a bright yellowish green. The bath is dropped or emptied and a fresh bath is set with 25g/l potassium carbonate. The temperature is raised to 150 degrees F and held there for 15 minutes. The bath is dropped and the fiber is rinsed cold. Inspection of the fiber showed it to be completely penetrated and very uniform.

### Example IX

A 30 inch wide carpet (20 yards) is tufted with 1360/2 JBT nylon, which had been Superba heat-set, into a 50 oz. cut pile construction. This carpet is installed in a sample beck (any kind) at a bath ratio of 40 to 1. The dyeing assistants, 1.0% Fourlev R and 1.0% Lanawet 916 are added. The following dye formulation is previnylized with potassium carbonate (as described in Example I) and added to the bath:

| | |
|---|---|
| 0.42% | Fourtex Yellow 2GR 150% |
| 0.38% | Fourtex Red 3B |
| 0.14% | Fourtex Navy S-G |

The pH of the beck dyebath is then set at 1.5 with Autoacid A-80 (sulfuric acid available from Peach State Labs). The temperature is raised to 200 degrees F and the bath is dropped. The carpet is rinsed with cold water and aftertreated (as described in EXAMPLE I) with a fresh bath containing 20g/l of potassium carbonate. The carpet is then dried at 260° F. It is a heavy reddish brown color and performs very well in AATCC cold-water bleed and hot shampoo testing.

TABLE 1
Dye Exhaust Comparison of Alkalis Used in Previnylization

| | Instrumental | Visual |
|---|---|---|
| | Chromatic @ 550 | Apparent |
| Example I Potassium Carbonate | 85.87% | 85.43% |
| Example II Lithium Carbonate | 86.68% | 86.14% |
| Example III Sodium Carbonate | 79.85% | 79.09% |
| Example IV Trisodium Phosphate | 84.16% | 83.33% |

TABLE 2
Dye Washout Comparison versus - K₂CO₃
Alkali Aftertreatment (Example I)

| | Chromatic @ 430 | Apparent |
|---|---|---|
| Example II Lithium Carbonate | −13.59% | 5.69% |
| Example III Sodium Carbonate | +60.18% | +68.67% |
| Example IV Trisodium Phosphate | +81.64% | +93.72% |

TABLE 3
Visual Ratings of 210° F. Overdye Test

| | Shade Change | Stain on KET |
|---|---|---|
| Example I Potassium Carbonate | 3 | 4-5 |
| Example II Lithium Carbonate | 4 | 5 |
| Example III Sodium Carbonate | 3 | 4 |
| Example IV Trisodium Phosphate | 2-3 | 4 |

What is claimed is:

1. A method for dyeing synthetic cationic dyeable fiber comprising, contacting said fiber with fiber reactive dye and covalently bonding said dye to said fiber with alkali metal carbonate.

2. A method according to claim 1, wherein said fiber comprises polyamide.

3. A method according to claim 1, wherein said fiber comprises nylon 66.

4. A method according to claim 1, wherein said alkali metal carbonate comprises sodium carbonate, lithium carbonate, potassium carbonate, or combinations thereof.

5. A method according to claim 1, wherein said alkali carbonate comprises potassium carbonate.

6. A method for making carpet comprising, dyeing synthetic cationic dyeable fiber with fiber reactive dye to form a dyed fiber; blending said dyed fiber with fiber comprising undyed synthetic acid dyeable fiber to form said carpet; and overdyeing said carpet with dye.

7. A method according to claim 6, wherein said fiber comprises polyamide.

8. A method according to claim 6, wherein said fiber comprises nylon 66.

9. A method for dyeing carpet comprising, dyeing synthetic cationic dyeable fiber with fiber reactive dye to form a dyed fiber and tufting or blending said dyed fiber with fiber comprising dyed or pigmented fiber.

10. A method according to claim 9, wherein said fiber comprises polyamide.

11. A method according to claim 9, wherein said fiber comprises nylon 66.

12. A dyed synthetic fiber comprising, synthetic cationic dyeable fiber dyed with fiber reactive dye, that is fixed to said fiber by alkali metal carbonate.

13. A dyed fiber according to claim 12, wherein said fiber comprises polyamide.

14. A dyed fiber according to claim 12, wherein said fiber comprises nylon 66.

15. A dyed fiber according to claim 12, wherein said alkali metal carbonate comprises sodium carbonate, lithium carbonate, potassium carbonate, or combinations thereof.

16. A dyed fiber according to claim 12, wherein said alkali carbonate comprises potassium carbonate.

17. A carpet made from the fiber of claim 12.

18. A mixture of fiber and dye comprising, synthetic cationic dyeable fiber, fiber reactive dye and alkali metal carbonate.

19. A mixture according to claim 18, wherein said fiber comprises polyamide.

20. A mixture according to claim 18, wherein said fiber comprises nylon 66.

21. A mixture according to claim 18, wherein said alkali metal carbonate comprises sodium carbonate, lithium carbonate, potassium carbonate, or combinations thereof.

22. A mixture according to claim 18, wherein said alkali metal carbonate comprises potassium carbonate.

23. A carpet comprising, synthetic cationic dyeable fiber dyed with fiber reactive dye and tufted with fiber comprising undyed synthetic acid dyeable fiber, said carpet overdyed with acid dye.

24. A carpet according to claim 23, wherein said fiber comprises polyamide.

25. A carpet according to claim 23, wherein said fiber comprises nylon 66.

26. A carpet according to claim 23, wherein said alkali metal carbonate comprises sodium carbonate, lithium carbonate, potassium carbonate, or combinations thereof.

27. A carpet according to claim 23, wherein said alkali metal carbonate comprises potassium carbonate.

28. A carpet comprising, synthetic cationic dyeable fiber dyed with a fiber reactive dye and tufted with fiber comprising dyed or pigmented fiber.

29. A carpet according to claim 28, wherein said fiber comprises polyamide.

30. A carpet according to claim 28, wherein said fiber comprises nylon 66.

31. A carpet according to claim 28, wherein said alkali metal carbonate comprises sodium carbonate, lithium carbonate, potassium carbonate or combinations thereof.

32. A carpet according to claim 28, wherein said alkali metal carbonate comprises potassium carbonate.
